(19) United States
(12) Patent Application Publication
(10) Pub. No.: US 2006/0137535 A1
(43) Pub. Date: Jun. 29, 2006

(54) Heating of products

(76) Inventor: Matthew J Searle, Somerset BA (GB)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/523,624

(22) PCT Filed: Aug. 6, 2003
(86) PCT No.: PCT/GB03/03399

§ 371 Date: Oct. 4, 2005

(30) Foreign Application Priority Data
Aug. 6, 2002 (GB) 0218270.7

(51) Int. Cl. A21B 7/00

(52) U.S. Cl. 99/348

(57) ABSTRACT

Food products such as wraps (100) are displayed, sold and subsequently heated in a heating apparatus (200). Within the heating apparatus (200) are reactants, such as quicklime and water which, when mixed, generate steam. An individual steam nozzle extends within the interior of each wrap and is arranged such that the steam generated is injected into the food product within its outer wrapper. The outer wrapper therefore acts to form a steam container whereby efficient heating of each wrap is achieved. Generally, the outer wrapper acts as an insulator to enable the heated wrap (100) to be safely handled.

The present invention relates to a method of heating a product and to apparatus for heating a product. Preferably, the apparatus and method of the invention relate to the heating of food products.

WO 96/29255 shows an example of a self-heating or self-cooling can. The self-heating can has a heating insert contained within a re-entrant base of the container and when quicklime and water contained within that insert are mixed the contents of the can are heated by the resulting exothermic reaction. However, the self-heating can utilises conduction and convection methods to transfer the heat of the reaction to the contents of the can, and for some products this can be too slow.

WO 02/085171 describes apparatus in which foods and other substances contained in bowls, trays and other containers are heated by the injection of steam into the container. The steam is thereby given free access to all parts of the contained substances and quick heating results.

However, neither of these methods of heating are applicable, for example, to the heating of snacks such as sandwiches, wraps, pasties and pies. If such snacks were to be heated by an apparatus as described in WO 02/085171, for example, their outer layers or casings would become too hot to hold, but the inside would stay cold.

It is an object of this invention to provide an alternative heating method which is applicable, for example, to snack foods.

According to a first aspect of the present invention there is provided a method of heating a product, where the product comprises a constituent contained within an outer wrapper, the method comprising the step of injecting a hot vapour into the constituent within the outer wrapper to heat the product.

Although this invention does have applicability to the heating of products other than food products, it is particularly advantageous where the product to be heated is a food product which comprises foodstuff contained within an outer wrapper.

In an embodiment, the outer wrapper may be of packaging material. For example, a sandwich or pie might be contained within a close fitting sandwich box, wrapped in foil or a plastics material, or enclosed within a plastics bag.

Alternatively, the outer wrapper may be edible and part of the food product itself, such as a pie crust, the pastry container of a pastie, or a wrap.

It will be apparent that a method of an embodiment of the invention provides for direct heating of the constituent of the product by the injection of a hot vapour therein, but that the outer wrapper, however it is configured, provides an insulating layer which will act to protect a user handling the product. The outer wrapper also provides the container within which the heating takes place.

Where the product is a food product, the hot vapour injected into the food product will generally be steam.

In an embodiment, the method further comprises the steps of activating a hot vapour generator to generate the hot vapour, putting a hot vapour outlet of the hot vapour generator into communication with the constituent within the outer wrapper to heat the product, and removing the communication between the hot vapour generator and the constituent.

For example, the hot vapour generator is arranged substantially adjacent to the product, and a hot vapour outlet tube is extended within the constituent within the outer wrapper of the product such that the hot vapour generated may heat the constituent.

The outlet of the hot vapour generator may be, or may incorporate, extendible means to enhance the communication of the hot vapour outlet with the constituent of the product.

The present invention also extends to apparatus for heating a product, where the product comprises a constituent contained within an outer wrapper, the apparatus comprising a support for the product, a hot vapour generator, and a nozzle insertable within a product provided on said support.

In a preferred embodiment, the support is provided by at least part of the hot vapour generator.

Preferably, the product to be heated is a food product and the hot vapour generator is a steam generator.

In an embodiment, the hot vapour generator is arranged substantially adjacent to the product, and a hot vapour outlet tube is extended within the constituent within the outer wrapper such that the hot vapour generated heats the constituent.

The communication between the product constituent and the hot vapour generator is arranged to be removed after heating.

The outlet of the hot vapour generator may be, or may incorporate, extendible means to enhance the communication of the hot vapour outlet with the constituent within the outer wrapper.

Preferably, the extendible means is arranged to be extended by the pressure of the hot vapour generated.

The extendible means may be a bellows or have a telescopic structure.

Preferably, said hot vapour outlet has a nozzle to impart a high velocity to the hot vapour to be delivered.

The present invention also relates to a method and apparatus for heating the contents of a container, and to a hot vapour generator.

Thus, it is sought to provide a method and apparatus for heating cans which can be used, for example, to provide heated beverages at a point of sale.

According to a further aspect of the present invention there is provided a method of heating the contents of a container, said method comprising the steps of activating a hot vapour generator to generate a hot vapour, putting a hot vapour outlet of the hot vapour generator into communication with the contents of a container to thereby heat the contents, and removing the communication between the hot vapour generator and the container contents.

The use of a hot vapour which is put into direct communication with the contents of a container provides fast and effective heating to those contents. As that communication is removed once the contents have been heated, a container with heated contents which could, for example, be dispensed at a point of sale is provided.

Preferably, particularly where the contents of the container are beverage or foodstuff, the hot vapour generator is a steam generator.

In one embodiment, the hot vapour generator is arranged substantially adjacent to an open container, and a hot vapour outlet tube is extended within the contents in the open container such that the hot vapour generated may heat those contents. Thereafter, the method comprises removing the communication between the container with its heated contents and the hot vapour generator.

In an alternative embodiment, the hot vapour generator is coupled to the container such that its outlet is in, or can be brought into communication with, the contents of the container. In a particularly preferred embodiment, the hot vapour generator is incorporated in, or form, a closure for the container.

In preferred embodiments, the outlet of the hot vapour generator may be or may incorporate, extensible means to enhance the communication of the hot vapour outlet with the contents of the container. Preferably, the extendible means is arranged to be extended by the pressure of the hot vapour generated.

The present invention also extends to apparatus for heating the contents of a container, said apparatus comprising a container, a hot vapour generator arranged to generate a hot vapour, said hot vapour generator having a hot vapour outlet arranged to be put into communication with the contents of the container to thereby heat the contents, wherein the communication between the hot vapour generator and the container contents is removable.

Preferably, the hot vapour generator is a steam generator.

In one embodiment, the hot vapour generator is arranged substantially adjacent to an open container, and a hot vapour outlet tube is extended within the contents in the open container such that the hot vapour generated may heat those contents. The communication between the container with its heated contents and the hot vapour generator is arranged to be removed after heating.

In an alternative embodiment, the hot vapour generator is coupled to the container such that its outlet is in, or can be brought into communication with, the contents of the container. In a particularly preferred embodiment, the hot vapour generator is incorporated in, or forms a closure for the container.

In preferred embodiments, the outlet of the hot vapour generator may be or may incorporate, extendible means to enhance the communication of the hot vapour outlet with the contents of the container. Preferably, the extendible means is arranged to be extended by the pressure of the hot vapour generated.

In an embodiment, the extendible means comprises a bellows.

In an alternative embodiment, the extendible means comprises a telescopic structure.

Preferably, the outlet has a nozzle to impart a high velocity to the hot vapour to be delivered.

In an embodiment, the hot vapour outlet extends through a wall of the container.

The wall through which the outlet extends may be any one of a bottom, top, or side wall. The vapour generation may be supported by the container with the hot vapour outlet tube in position extending into the contents of the container. Alternatively, the hot vapour generator may be arranged on or proximate to the container such that the outlet tube can be extended through the wall. The extension of the outlet tube may be arranged to occur on activation of the hot vapour generator to generate hot vapour.

Alternatively, the outlet tube of the hot vapour generator is extended into the contents of the container through a mouth opening thereof.

In the embodiments defined above, the container may be of a rigid material, of a flexible material, or some combination. For example, the container may be a can, a bottle, a plastics beaker or container, or a pouch.

According to a further aspect of the present invention there is provided a hot vapour generator comprising a closed casing separated into first and second containers by an internal wall, a respective one of first and second reagents, which react together to generate a hot vapour, being contained within each of said first and second containers, and operating means to cause breakage or removal of said internal wall whereby said first and second reagents are mixed and generate said hot vapour, said hot vapour generator further comprising an elongate hollow tube having a first end in communication with the interior of said casing whereby the hot vapour generated is delivered to a second outlet end of said elongate hollow tube.

Hot vapour generators of embodiments of the invention may be steam generators. In that case, it is presently preferred that the first and second reagents are, or include, water and quicklime.

When a hot vapour generator is to be used with an opened container to heat its contents, the elongate hollow tube may be a flexible tube which can be positioned so that its outlet end can be immersed in the contents of the container.

In alternative embodiments, the elongate hollow tube is extendible, preferably by way of the pressure of the hot vapour generated. For example, the elongate hollow tube may comprise an extendible bellows or may have an extendible telescopic structure.

A nozzle to increase the pressure of the hot vapour output may be provided on the outlet end of the elongate hollow tube.

In a particularly preferred embodiment, the hot vapour generator is incorporated within a module which is removably coupled to a container such that the outlet end of the elongate hollow tube is put into communication with the contents of the container by the generation of the hot vapour.

Currently it is preferred that the hot vapour generator be incorporated in a closure for a container.

It will be appreciated that where a hot vapour generator is incorporated into a container closure, the closure, and hence the hot vapour generator, may be discarded after heating of the contents and opening of the container.

The container may be of any appropriate type and made of any appropriate material. As well as containers made of relatively rigid materials such as plastics, metal or glass, container made of flexible or non rigid materials such as plastics or foils may be used.

An embodiment of a hot vapour generator as defined above may comprise one or more of the features of the apparatus for heating the contents of a container as described above.

Embodiments of the present invention will hereinafter be described, by way of example, with reference to the accompanying drawings, in which:

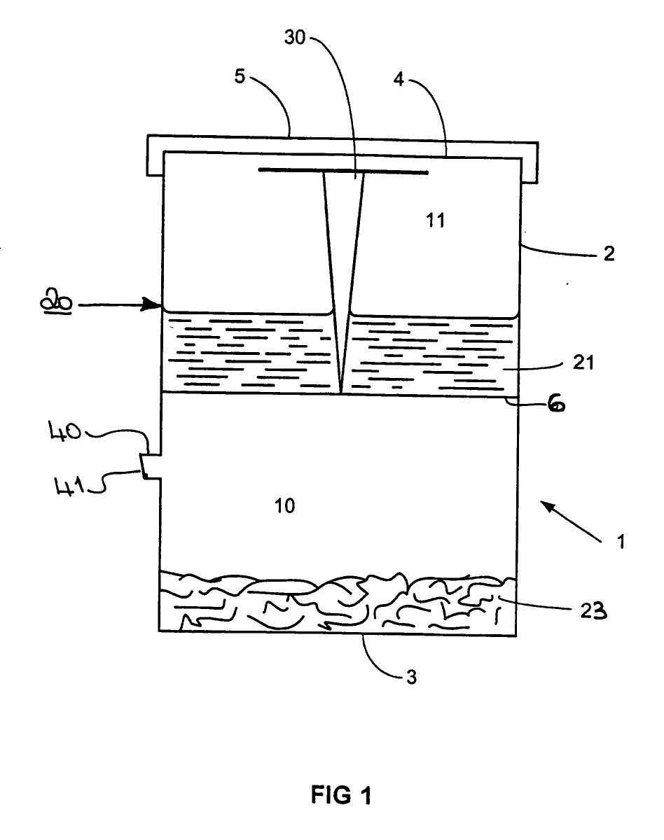

FIG. 1 shows a cross section of one embodiment of a steam generator module,

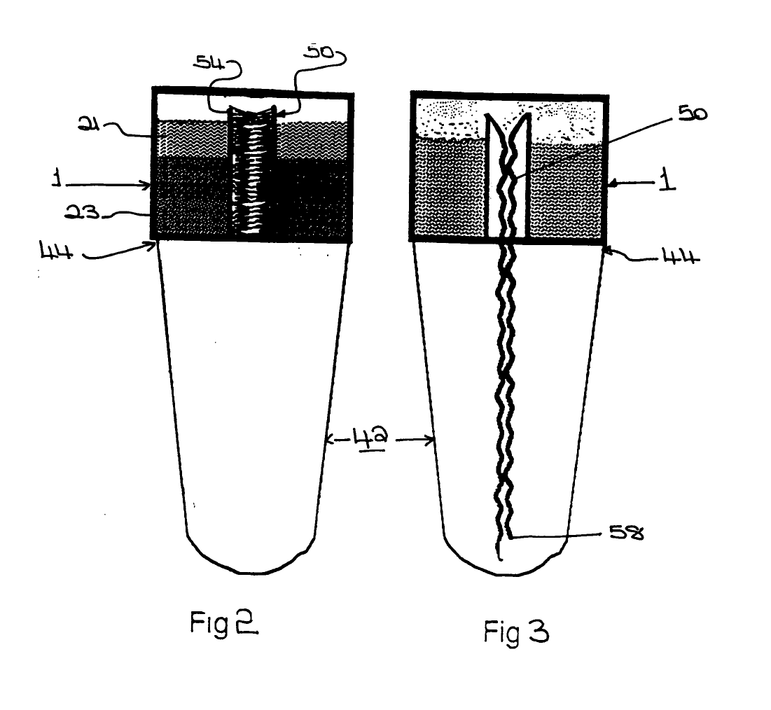

FIG. 2 shows schematically a container with a removable steam generator module, the module having an extendible bellows,

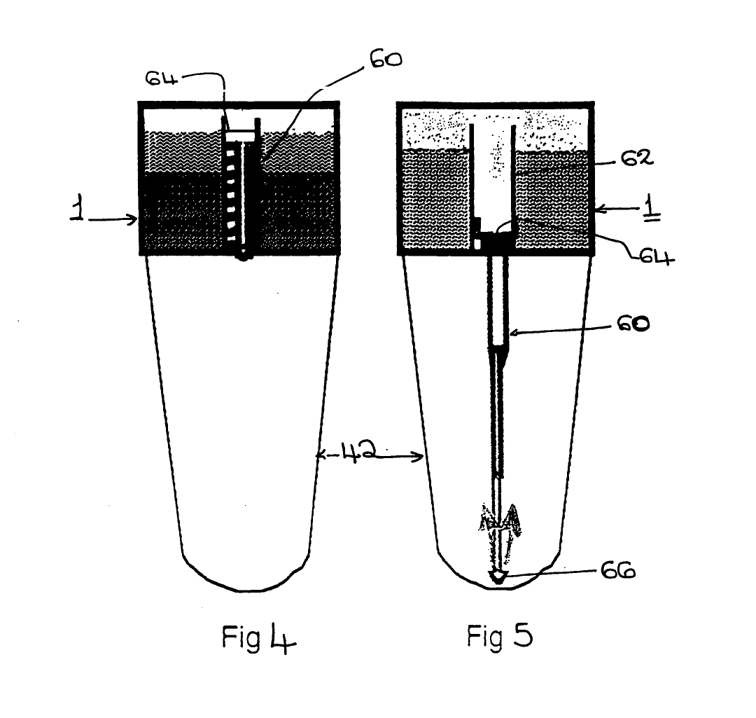

FIG. 3 shows the container of FIG. 2 with the bellows extended,

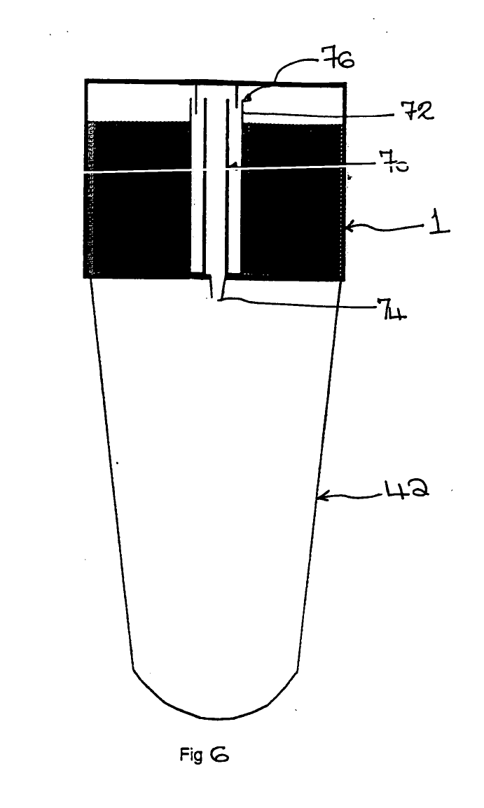

FIG. 4 shows schematically an alternative embodiment of a container with a removable steam generator module, where the module has a telescopic structure,

FIG. 5 shows the container of FIG. 4, with the telescopic structure extended,

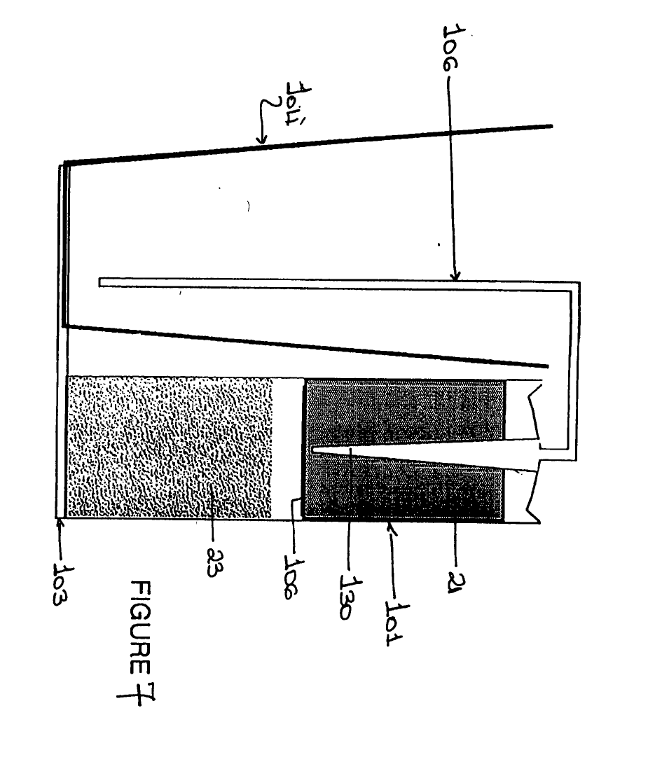

FIG. 6 shows a further embodiment of a container with a removable steam generator module,

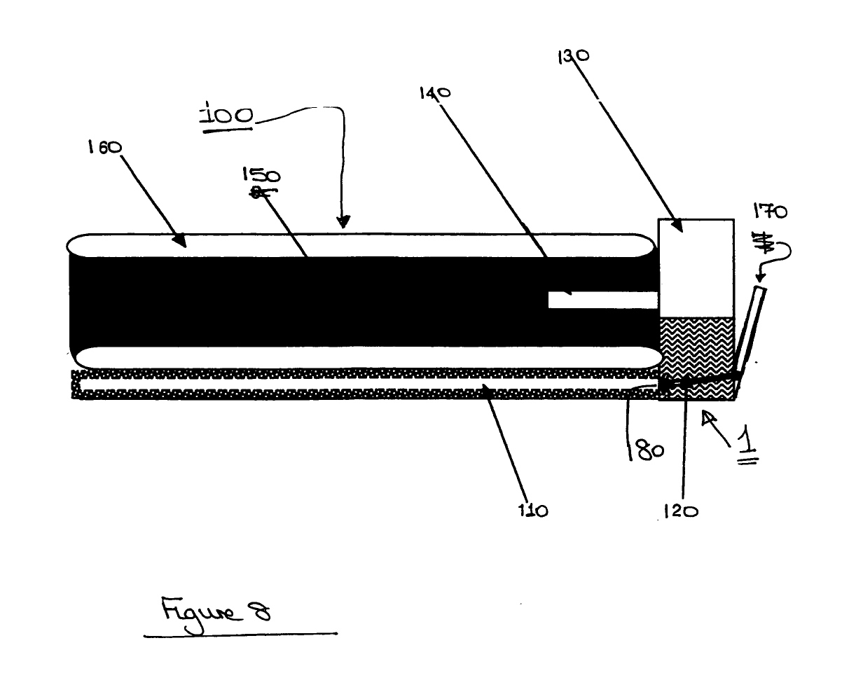

FIG. 7 shows schematically a container with a separate steam generator module,

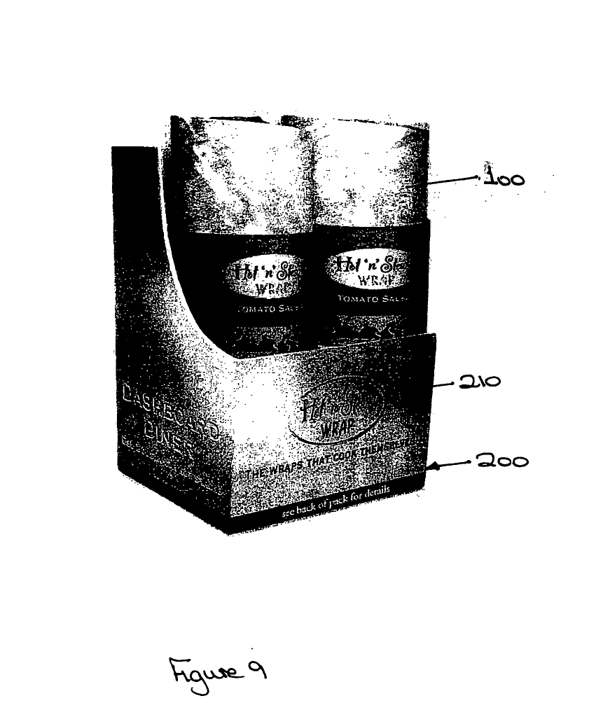

FIG. 8 shows a cross section through a food product in situ in apparatus for heating the food product, and

FIG. 9 shows a perspective view of an apparatus for heating two wraps.

In the various figures like reference numerals refer to the same or similar parts.

This invention is concerned with the heating of products which have a constituent within an outer wrapper. Generally, the product will be a food product having a foodstuff contained within an outer wrapper which may or may not be edible. However, non-foodstuff products may also be heated by a method of this invention. Such non-foodstuff products may include, for example, a towel received within a plastics bag, or a leg wax housed within a plastics pouch.

Thus, the present invention is not limited to the specific nature of the product and any product which can be heated by a hot gas without spoiling or adversely reacting can be heated by a method of the invention.

In preferred embodiments, the invention is concerned with heating the product using steam which has been locally and contemporaneously generated. However, where contents other than foodstuffs are to be heated, it may be preferred to use heated gases and vapours obtained from sources other than water. Clearly, for local generation, sources which vaporise readily and attain acceptable temperatures will be preferred.

There are described herein methods of heating the contents of a container utilising the local generation of vapour and the structures of hot vapour generators described may be used or adapted for use with the methods and apparatus described for heating products which have a constituent within an outer wrapper.

FIGS. 1 to 7 generally illustrate the heating of the contents of containers. These structures are described and illustrated herein to illustrate methods and structures for the local generation of vapour which may be used to heat products where an outer wrapper of the product takes the place of the container. It will be appreciated that these methods and structures can also be used independently of the invention relating to the heating of products. For such independent use the container may be a pouch, for example. Similarly, the configuration or construction of the container can be chosen as required. For example, a container may have rigid, non-rigid, or flexible walls.

WO 96/29255 shows an example of a self heating or self cooling can. A self heating can as described in this specification which incorporates a self heating insert containing quicklime and water has proved successful in the market place. In this respect, the heating insert is contained within a re-entrant base of the container and when the quicklime and water therein are mixed, the contents of the can are heated by the resulting exothermal reaction.

Whilst a can as described in WO 96/29255 is very successful it can take about three minutes for the contents of a regular sized can to be heated. Furthermore, when the heated contents of the can have been dispensed, the can, which still retains the heating insert, is relatively heavy.

There are occasions when it is required to dispense heated beverages, for example, at a point of sale where conventional heating means are inconvenient or unavailable. In such a location, it would be desirable to provide to a customer a container whose contents have been heated. Of course, the customer will require that the contents can be heated quickly. The sales staff will require that the operation of the heating means is simple and effective. FIGS. 1 to 7 show embodiments which meet these needs by providing a self-heating container which can heat the contents quickly.

It has been determined that heating the contents of a container by injecting steam is very effective and causes faster heating than the conductive/convective methods used, for example, in the self-heating can of WO 96/29255. The embodiments of FIGS. 1 to 7 therefore provide a portable and/or removable steam generator module which can be associated with a container and used to generate steam when required to heat the container contents. The steam generator module can be removed from the container after its contents have been heated.

As set out above, hot vapours and gases from sources other than water may be used to heat a container's contents. However, for clarity, the embodiments illustrated are specifically described below with reference to the heating of beverages or foodstuffs by locally generated steam.

The structure of the hot vapour generator module, for example, to generate steam, may be chosen as required. For steam generation it is generally preferred to use quicklime and water as the reagents as the reaction time thereof is fast and effective. However, the steam generating reagents and the particular structure of the steam generator module may be chosen as is required.

FIG. 1 shows one embodiment of a steam generator module 1. A steam generation module as illustrated in FIG. 1 is shown, for example, in WO 01/91621. The earlier specification explains how the ratio of a first reactant to a second reactant in a steam generator module 1 can be changed to generate the steam pressures and temperatures required.

The steam generator module illustrated in FIG. 1 comprises an outer casing 20 formed by a substantially cylindrical peripheral wall 2 having a substantially circular base 3. A substantially circular top wall 4 closes the casing 20. In the embodiment illustrated, an outer protective cover 5 is engaged on a top edge of the peripheral wall 2 to enclose the top wall 4.

The casing 20 is divided into a first, lower container 10 and a second, upper container 11 by way of an internal wall 6 which extends across the casing. In the embodiment illustrated, the internal wall 6 divides the casing 20 into two substantially equally sized containers, but the relative size of the containers 10, 11, will depend upon the performance requirements for the steam generator module 1. The wall 6 is arranged to be breakable or rupturable.

As stated above, the materials used in the steam generating module 1 are generally quicklime (calcium oxide) 23 which is provided in the lower container 10, and water 21 which is contained in the upper container 11. The quicklime 23 may be provided as a powder, or in any other desired form. In one embodiment, the quicklime may be mixed with a granular material, for example plastic granules, to facilitate mixing with the water.

In order to generate steam it is necessary to provide operational means to break, rupture or pierce the internal wall 6. The nature of the operational means will be determined by the structure of the wall 6 and/or by the nature of the material from which it is formed. Where, for example, the material is frangible or rupturable, a piercing device as indicated at 30 may be provided. This piercing device 30 is a generally elongate, conically shaped, plastics member which is carried by way of appropriate means, not shown, on the top wall 4. The free end of the piercing member 30 has one or more points and is in contact with, or in close proximity to, the internal wall 6 such that depression of the piercing member 30 is effective to break or rupture the wall 6.

An outlet 40 is provided in the first container 10 to allow the exit of steam generated within the module. A releasable closure or value 41 may be disposed on the outlet 40, such that, before use, the quicklime 23 is in an hermetically sealed container 10. This prevents slaking of the quicklime due to atmospheric moisture and gives a long shelf life to the steam generator module.

In use, the protective cover 5 is removed from the top of the steam generator module 1 so that pressure can be exerted on a central region of the top wall 4. This depresses the piercing member 30 whereby its free end contacts and breaks the internal wall 6. Water 21 is thereby able to flow out of the upper container 11 and to mix with the quicklime 23 in the lower container to cause an exothermic reaction which generates steam. The pressure of the generated steam can be allowed to open the closure or valve 41 whereby the steam can leave via the outlet 40 and be used to heat the contents of a container as described further below.

Modifications may be made to the positioning of the water and of the quicklime within the steam generator module 1 and the contents of the first and second containers 10, 11, may be reversed, or the containers may be positioned transversely adjacent to one another. However, it is generally preferred to have the water above the quicklime, as in the illustrated embodiment, as by this means, gravity assists the reaction.

As described, the internal wall 6 of the steam generator module 1 is breakable or rupturable to enable the quicklime and water to mix. It will, however, be clear that any suitable means may be provided to separate the two reagents initially and to allow their mixture when required. For example, an ejectable lid, twist cap or other mechanical device forming a temporary seal might be provided. Where a breakable or rupturable wall 6 is provided, alternative devices may be used for tearing or piercing the material of the wall 6.

The steam generator module 1, for example, as shown in FIG. 1, may be used as removable heating means for a container. FIGS. 2 to 5 show schematically containers which have a removable steam generator as a closure for the container.

FIGS. 2 and 3 show schematically a container generally indicated at 42 having a closure in the form of a steam generator module 1. In this respect, the structure of the container 42 and the material from it is made can be chosen as required. Thus, the container might be substantially in the form a cup or mug or it may be in the form of a can or bottle. The container may be of a plastics material or of a metal and will be arranged to contain appropriate contents. Presently it is preferred that the container 42 be used to contain beverages or foodstuffs.

The steam generator module 1 may be the only closure of the container 42 and be secured, by appropriate means, on an open mouth opening 44 of the container. Alternatively, the mouth opening 44 of the container may have a closure and the steam generator closure 1 is then affixed to the container 42 adjacent to the closure at its mouth opening 44. In this latter circumstance, the container closure may be a foil web, for example, affixed across the mouth opening 44 to seal the mouth opening.

It will be seen from FIGS. 2 and 3 that the closure 1 features two compartments in which quicklime and water are separately stored whereby steam can be generated by causing the mixture of the two reagents. In this respect, in FIG. 2 the water 21 and the quicklime 23 are indicated but the structure separating the two compartments and the operational means for causing the two reagents to mix are not apparent. It will be appreciated that any appropriate operating means may be provided.

In the embodiment shown in FIG. 2, the steam generator closure 1 is shown as comprising an expandable bellows 50 which extends longitudinally of the closure through the containers of quicklime 23 and water 21 to protrude above the level of the water 21 initially. In the initial state, the bellows 50 is compressed. It may be that the structure of the bellows 50 can be such that in its compressed state it reliably prevents exit of water 21 from its container 11 through the bellows. Alternatively, a releasable closure (not shown) may be provided at the upstanding end 54 of the compressed bellows 50.

In use, the steam generator module 1 is affixed to the container 42, which has been filled, as its closure. For example, the steam generator closure 1 may have been fixed onto the container 42 by way of a screw thread or by any other appropriate means. When it is required to heat the contents of the container 42, the steam generator closure 1 is activated by its operating means, for example, as described above with reference to FIG. 1, such that steam is generated. In this respect, the quantities and nature of the reagents within the steam generator closure 1 are chosen such that steam of a sufficient pressure is generated. The steam pressure then causes the releasable closure 54 at the end of the bellows 50 to open, and also causes the bellows 50 to extend. This is shown in FIG. 3. It will be immediately apparent that the generated steam is able to travel along the extended bellows 50 and to exit from an open end 58 thereof. In this way, hot steam is injected into the contents of the container 42 whereby those contents are heated.

Where there is a foil closure, for example, at the mouth opening 44 of the container 42, the free end 58 of the bellows 50 can be arranged to pierce that foil closure during extension of the bellows to allow for injection of the steam.

Once the steam generator closure 1 has been operated to generate the steam it could be slowly removed. Additionally and/or alternatively, indicating means may be provided on the closure 1 to show when steam generation has ceased. Alternatively, the closure 1 can be unscrewed, unclipped or otherwise unfastened from the container 42 after steam generation has commenced and held with the extended bellows 50 immersed within the contents of the container 42 until such time as steam exit from the end 58 of the bellows 50 has ceased. At this stage, the steam generator closure 1 can be discarded whereby the user then has a container 42 with heated contents.

FIGS. 4 and 5 show a similar arrangement to that of FIGS. 2 and 3 in which a container shown schematically at 42 is also provided with a steam generator closure 1. However, in the embodiment shown in FIGS. 4 and 5 a telescopic structure 60 replaces the bellows as the steam delivery means. In this respect, the telescopic structure 60 comprises a number of interengaged hollow rods which telescope into one another and are received within an elongate tube 62. A piston 64 fixed to one end of the telescopic structure acts as a closure for the tube 62 in the initial position of FIG. 4. When the steam is generated within the closure 1 it acts on the piston 64 which, as a result, is slid along the bore of the tube 62 whereby the telescopic structure 60 is moved out of the bore. A passage for steam (not shown) is then opened by way of the tube 62 and the piston 64 into the interior of the telescopic structure 60. The steam fed within the telescopic structure 60 extends the rods thereof and is injected into the contents of the container 42 at an open end 66 thereof.

FIG. 6 shows a still further embodiment of a container 42 with a steam generator closure 1 thereon. In this embodiment, an elongate tube 70 extends through the closure 1 and protrudes through its base to form a nozzle 74. This tube 70 is housed within an outer tube 72 which similarly extends within the closure 1. A releasable closure for the outer tube 72 is indicated at 76. In this respect, when steam is generated it is able to open the closure 76 and is then discharged into the container 42 by way of the nozzle 74. The nozzle 74 is able to jet steam at high velocity into the interior of the container, and hence into its contents whereby effective heating of the contents is provided.

In each of the embodiments shown in FIGS. 2 to 6, the steam generator 1 is incorporated in the removable closure of the container 42. The provision of a steam generating closure is particularly effective as, when access to the contents is required, the closure is generally discarded.

However, and if required, it would be alternatively possible to provide a separate steam generator and to provide means of injecting the steam it generates into the contents of a container. For example, a container may be provided with a valve or a point of weakening in a wall thereof so that when heating of its contents is required, a steam generator, for example as shown in any of FIGS. 1 to 6, may be engaged with the container such that its steam outlet is aligned with the valve or point of weakening. To enable steam to be injected into the container upon operation of the steam generator it is necessary to provide means to couple the outlet with the container and to open the valve or point of weakening. In this respect, if the steam generator uses an extendible structure such as a bellows or a telescopic rod structure, the steam generator would generally be coupled at the top or bottom end of a container. If the steam generator were to be coupled to a side or peripheral wall of a container, steam injection by way of a nozzle as shown in FIG. 6 would generally be preferred.

It is also possible to provide a separate steam generator which may be held, for example, at the mouth opening of an opened container and operated to generate steam which is to be delivered into the contents of the container. Alternatively, the steam generator may be arranged so that a user does not need to hold it whilst the contents of a container are heated.

In FIG. 7 there is shown an arrangement in which a steam generator 101 is fixed onto a base 103 on which a container 104 may be supported. The steam generator 101 has, as will be apparent, an outlet tube 106 which extends from a top surface thereof and into the container 104. This outlet tube 106 is preferably flexible to enable the container to be positioned as illustrated and subsequently removed. As previously, the steam generator 101 encloses water 21 and quicklime 23 in their respective, separated compartments. An elongate hollow piercing member 130 is provided and is enabled to break or rupture an internal wall 106 therein whereby steam is generated. The interior of the hollow piercing member 130 communicates with the interior of the outlet tube 106. This enables steam to travel through the piercing member 130 and the tube 106 and to exit from the tube 106 to heat the contents in the container 104.

With an arrangement as shown in FIG. 7, it may be preferred to have a generally cylindrical outer wall (not shown) fixed onto the base 103 for receiving a cartridge comprising the steam generator 101. This cartridge may then be coupled with the elongate piercing member 130 and the outlet tube 106 to enable an apparatus as shown in FIG. 7 to be utilised to heat the contents of a number of containers.

As is set out above, the present invention is primarily concerned with the heating of food products having a foodstuff contained within an outer wrapper. In these circumstances the structures described above and illustrated in FIGS. 1 to 7 are adapted such that the outer wrapper of the food product effectively forms the container.

FIG. 8 shows a particular embodiment of a heating apparatus which is presently preferred and which is specifically designed for heating a snack food product. The food product illustrated is a sandwich 100 comprising a filling 150 of appropriate foodstuffs provided between layers of bread 160.

As is shown in FIG. 8, the heating apparatus has a steam generator module 1 which comprises a hollow support 110 for the food product 100. The hollow support 110 defines a chamber for receiving a first reactant material, for example, such as quicklime. The chamber within the support 110 is arranged to be put into communication with an upstanding chamber 120 in which a second reactant material, such as water, is provided. Initially, the chambers 110 and 120 are separated from each other but when they are put in communication by way of appropriate activating means, indicated at 170, steam will be generated within a headspace 130 within the chamber 120.

An elongate nozzle 140 which, for example, may be configured as any of the injection nozzles described above, communicates with the headspace 130. When the food product 100 is placed onto the support 110 it is arranged such that the nozzle 140 extends within the foodstuff 150. It will therefore be appreciated that any steam within the headspace 130 will be injected into the food product but between the layers 160. The layers 160 therefore act to form a steam container whereby efficient heating of the foodstuff 150 is achieved. In due course, there may be some heating of the outer layers 160 but in general, these layers will act as insulators to enable the heated product 100 to be safely handled.

The structure of the chambers 1 10 and 120, and the nature of their separation can be chosen as required to suit the circumstances. Generally, a breakable or rupturable membrane, as indicated at 180, will be provided. However, a removable mechanical closure may alternatively be provided. Clearly, the nature of the activating means 170 will be chosen to be appropriate to the nature of the separation means.

The food product 100 illustrated is not enclosed by the layers 160 which form the outer wrapper. This enables the steam to be vented readily. In general, the steam will condense in the foodstuff, but if required steam guards may be provided to prevent a user of the apparatus from coming into contact with the steam.

Where the product to be heated is entirely enclosed by its wrapper, for example, is a pie within a crust, any steam not condensed in the foodstuff will generally diffuse through the crust. Where the outer wrapper is impervious, for example, the product is a towel within a plastics bag, or a sandwich within a sandwich box, appropriate vents should be provided.

FIG. 9 shows a perspective view of an apparatus 200 for displaying, supporting and subsequently heating two wraps 100. For hygiene each wrap 100 is initially encased in appropriate outer packaging. The apparatus 200 comprises a support 210 within which an appropriate steam generator module (not visible) is provided. When it is required to eat the wraps the protective outer packaging may be removed and the steam generator module activated such that steam is injected into the foodstuff within each wrap by a respective nozzle (not visible).

It will be appreciated that modifications and alterations to the embodiment as described and illustrated may be made within the scope of the present invention.

1-43. (canceled)

44. A portable apparatus for heating consumable food product of the type comprising an outer wrapper and a filling, the apparatus comprising:
a support configured and arranged to support a foodstuff;
a vapor injection nozzle arranged to penetrate the filling of the foodstuff when the foodstuff is arranged for heating on the support, and
a heater unit that is user activatable to enable chemical reagents separately contained within the heater unit to contact one another and react to generate a hot vapor for heating the foodstuff;
whereby the apparatus is configured such that on activation of the heater unit by a user, hot vapor generated on contact of the reagents is directed through the injection nozzle and into the filling of the foodstuff thereby to apply heat directly to the filling.

45. Portable apparatus as claimed in claim 44, wherein said outer wrapper is edible and part of the food product itself.

46. Portable apparatus as claimed in claim 44, wherein said outer wrapper comprises packaging material.

47. Portable apparatus according to claim 44, wherein said heater unit comprises a frangible barrier arranged to separate said reagents, said barrier being configured to break on activation of the unit by a user thereby to enable said chemical reagents to contact one another.

48. Portable apparatus according to claim 47, comprising an activator operable by a user to break said frangible barrier.

49. Portable apparatus according to claim 44, wherein said hot vapor comprises steam.

50. Portable apparatus according to claim 49, wherein said separated chemical regents include quicklime and water.

51. Portable apparatus according to claim 44, comprising an extendible coupling configured to connect said nozzle and said heater unit.

52. Portable apparatus according to claim 44, wherein only said filling is directly heated by said hot vapor, said wrapper acting as an insulator such that the food product once heated can be held in the hand.

53. A method of heating a food product, wherein the food product comprises a filling contained within an edible outer wrapper, the method comprising the steps of: operating a heater unit to provide hot vapor, and infecting said hot vapor into the filling contained within said edible outer wrapper to heat said food product.

54. A method as claimed in claim 53, wherein the step of operating the heater unit comprises operating a heater unit activator.

55. A method as claimed in claim 54, comprising on operation of the activator the step of mixing reagents that react with one another to provide said hot vapor.

56. A method as claimed in claim 53, comprising supporting said food product for heating on said heater unit.

57. A method as claimed in claim 53, comprising inserting a nozzle coupled to said heater unit into the food product filling, hot vapor provided on operation of the heater unit passing through said nozzle and into said filling to heat said food product.

58. A method as claimed in claim 57, comprising the steam of supporting the food product for heating on said heater unit, the support of said food product on said heater unit causing said nozzle to penetrate the food product filling.

59. A nozzle according to claim 57, comprising the step of removing the nozzle from the food product filling prior to consumption of the food product.

60. Apparatus for displaying, supporting and subsequently heating an edible food product, said food product comprising an edible wrapper containing an edible filling and being wrapped in removable inedible packaging; the apparatus comprising:
a housing comprising a hollow housing main body and a front wall assembly projecting outwardly from said housing main body to define a food product support region in which a food product wrapped in removable inedible packaging can be supported adjacent the housing main body for display;
first and second separated reagent chambers defined within said hollow housing and containing first and second reagents respectively, said first and second reagents being capable of reacting with one another on contact to generate a hot vapor;
an activator operable by a user to couple said first and second chambers and thereby permit said first and second reagents to come into contact with one another to generate said hot vapor;
an injection nozzle arranged in use in said food product support region; said nozzle being configured, following support of said edible food product in said food product support region for heating, to penetrate the filling contained within the wrapper; and
a coupling between said injection nozzle and said hollow housing main body;
wherein the apparatus is configured and arranged;
to permit the display of a food product wrapped in removable inedible packaging prior to consumption of the food product;
to permit the support of the food product in said food product support region such that the injection nozzle penetrates the filling, and
on activation of said activator to permit said first and second reagents to come into contact with one another to generate hot vapor for direction by said coupling from said hollow main housing body through said nozzle and into said filling to heat said food product.

61. Apparatus according to claim 60, wherein said first and second reagents comprise water and quicklime, respectively and said hot vapor comprises steam.

62. Apparatus according to claim 60, wherein said food product is selected from a sandwich, a pie, a pastie and a wrap.

63. Apparatus according to claim 60, wherein the food product support region is configured to support a plurality of food products, and the apparatus comprises a plurality of injection nozzles such that a plurality of food products may be heated simultaneously.
